(19) United States
(12) Patent Application Publication
(10) Pub. No.: US 2026/0354426 A1
(43) Pub. Date: Nov. 12, 2026

(54) COLORING COMPOSITIONS FOR CONSUMABLES

(71) Applicant: GIVAUDAN SA, VERNIER (CH)

(72) Inventors: Rudolf RINGGENBERG, Kemptthal (CH); Fabienne BOUKOBZA-RAVEY, Bedford Park, IL (US); Kerry WEBSTER, Swadlincote, Derbyshire (GB); Nelly Bulgarelli, Chicago, IL (US)

(21) Appl. No.: 19/129,860

(22) PCT Filed: Nov. 22, 2023
(86) PCT No.: PCT/EP2023/082712

§ 371 Date: May 14, 2025

Related U.S. Application Data
(60) Provisional application No. 63/427,184, filed on Nov. 22, 2022.

(51) Int. Cl. A23L 5/43; A23C 9/152; A23L 2/39; A23L 2/58; A23P 10/35; A23P 10/40

(52) U.S. Cl. CPC A23L 5/43; A23C 9/152; A23L 2/39; A23L 2/58; A23P 10/35; A23P 10/40

(57) ABSTRACT

A composition for effecting color change of a consumable, wherein the composition comprises a first color delivery system comprising first core particles at least partially coated with a first colorant, and wherein the at least partially coated first core particles are at least partially encapsulated by a first encapsulant, wherein the composition changes the color of the consumable in response to temperature, mechanical agitation, passage of time, or combinations thereof.

A process for changing the color of a consumable, such as a beverage, using the composition, and consumables including the composition are also disclosed.

### TECHNICAL FIELD

The present disclosure relates to coloring compositions and methods for effecting color change in consumables, including beverages and bakery products.

### BACKGROUND

Color is one of the most important sensory properties in the food and beverage industry. Because consumer's look at a beverage or food product before consuming it, their eyes send signals to their brain well before their taste buds get the chance. This can predetermine how consumers will perceive certain characteristics of what they are about to eat, such as taste, flavor, mouthfeel, intensity, quality, sweetness, pleasantness, and acceptability. Research has demonstrated that changing the hue or intensity/saturation of the color of beverage or food products has a direct impact on a consumer's experience. Colorful beverages or foods can influence a consumer's brain to create an expectation that specific colors will taste a certain way. For example, the more vibrantly colored a food is, the more intense a consumer will expect its flavor to be.

Color is so powerful that it can override other senses of a consumer, causing them to taste sweetness in a beverage or food product that is not really there and experience flavors that are not present. Color also has a powerful effect on a consumer's emotions, such as happiness, hunger, and relaxation. Warm colors such as red, orange, and yellow are often associated with happiness, optimism, and energy. Different shades of the color red are often associated with love, sensuality, confidence, energy, joy, heat, and excitement. Different shades of the color pink are often associated with sensitivity, soft, sweet, beauty, joy, amusement, and pleasure. Cool colors such as green, blue and purple are associated with calming. Different shades of the color blue are often associated with relaxation, caring, contentment, cool, happiness, pleasure, relief, and tranquility. Different shades of the color green are often associated with fresh, healthy, interest, joy, natural, pleasure, relief and youth. The color purple often sparks creativity as it combines blue and red (calm and intense).

Consumers are always searching for moments of amusement and novelty. Changing colors of a consumable can create a fun, interactive, and multisensorial experience for consumers. It can also surprise and delight consumers, improving their overall experience. Chefs and mixologists have also become increasingly interested in changing the color of the foods and drinks they serve to surprise or entertain their guests and to create a unique and memorable experience.

There exists a continuing need for new and improved coloring compositions for consumables and methods for effecting color change in consumables in a predictable and controlled manner.

### SUMMARY

In one embodiment, a composition for effecting color change of a consumable, wherein the composition comprises a first color delivery system comprising first core particles at least partially coated with a first colorant, and wherein the at least partially coated first core particles are at least partially encapsulated by a first encapsulant, wherein the composition changes the color of the consumable in response to temperature, mechanical agitation, passage of time, or combinations thereof.

In another embodiment, a composition for effecting color change of a consumable, wherein the composition comprises a first color delivery system comprising first core particles at least partially coated with a first colorant, and wherein the at least partially coated first core particles are at least partially encapsulated by a first encapsulant; and a second color delivery system comprising second core particles at least partially coated with a second colorant comprising a color that is different from the color of the first colorant, and wherein the at least partially coated second core particles are at least partially encapsulated by a second encapsulant, wherein the first encapsulant is the same or different than the second encapsulant.

In another embodiment, a consumable including a composition for effecting colour change therein, wherein the composition comprises a first color delivery system comprising first core particles at least partially coated with a first colorant, and wherein the at least partially coated first core particles are at least partially encapsulated by a first encapsulant.

In another embodiment, a beverage powder mix comprising a first color delivery system comprising first core particles at least partially coated with a first colorant, and wherein the at least partially coated first core particles are at least partially encapsulated by a first encapsulant; and a second color delivery system comprising second core particles at least partially coated with a second colorant comprising a color that is different from the color of the first colorant, and wherein the at least partially coated second core particles are at least partially encapsulated by a second encapsulant, wherein the first encapsulant is the same or different than the second encapsulant, wherein the powder mix changes the color of a beverage over a period of time in response to temperature, mechanical agitation, passage of time, or combinations thereof, when the powder mix is added to the beverage.

In yet another embodiment, a process for changing the color of a consumable comprising: adding a composition comprising a first color delivery system comprising first core particles at least partially coated with a first colorant and wherein the at least partially coated first core particles are at least partially encapsulated by a first encapsulant to the consumable, and i) altering the temperature of the consumable to a predetermined temperature that is sufficient to release the first colorant, ii) mixing the consumable for a predetermined period of time that is sufficient to release the first colorant, or iii) allowing the consumable to sit for a predetermined period of time that is sufficient to release the first colorant. The composition of this embodiment may also include a second color delivery system as disclosed herein.

These and other features, aspects and advantages of specific embodiments will become evident to those skilled in the art from a reading of the present disclosure.

### BRIEF DESCRIPTION OF DRAWINGS

FIG. 1 is a schematic cross-sectional view of an illustrative composition for effecting color change of a consumable, wherein the composition comprises a first color delivery system comprising a plurality of first core particles coated with a first colorant, and wherein the at least partially coated first core particles are encapsulated by a first encapsulant.

FIG. 2 is a schematic cross-sectional view of an illustrative composition for effecting color change of a consumable, wherein the composition comprises a first color delivery system comprising a single first core particle coated with a first colorant, and wherein the at least partially coated first core particle is encapsulated by a first encapsulant.

FIG. 3 is a schematic cross-sectional view of an illustrative composition for effecting color change of a consumable, wherein the composition comprises a first color delivery system comprising first core particles coated with a first colorant and a flavorant, and wherein the at least partially coated first core particles are encapsulated by a first encapsulant.

FIG. 4A is a schematic cross-sectional view of an illustrative composition for effecting color change of a consumable, wherein the composition comprises a first color delivery system comprising first core particles coated with a first colorant and a flavorant, and wherein the at least partially coated first core particles are encapsulated by methylcellulose.

FIG. 4B is a schematic cross-sectional view of an illustrative composition for effecting color change of a consumable, wherein the composition comprises a first color delivery system comprising first core particles coated with a first colorant and a flavorant, and wherein the at least partially coated first core particles are encapsulated by a fat having a melting point of at least 50 °C.

FIG. 5 is a photograph of cold milk (from about 0 °C to about 5 °C) after the initial addition of an illustrative composition thereto (left, having a banana yellow color), after 1 minute of stirring (middle, having a chocolate/banana color), and after mixing (right, having a chocolate color).

FIG. 6 is a photograph of cold milk after the initial addition of an illustrative composition thereto (left, having a milk chocolate color) and after mixing (right, having a dark chocolate color).

FIG. 7 is a photograph of cold milk after the initial addition of an illustrative composition thereto (left, having a yellow color), after 1 minute (having a yellowish/orange color), after 2 minutes (having an orangish/yellow color), and after 3 minutes (having a mango/orange color).

FIG. 8 is a photograph of cold milk after the initial addition of an illustrative composition thereto (left, having a strawberry pink color), after 1 minute (having a pinkish/purple color), after 2 minutes (having a purplish/pink color), and after 3 minutes (having a blueberry/purple color).

FIG. 9 is a photograph of cold milk after the initial addition of an illustrative composition thereto (left, having a milk chocolate color) and after heating to at least 50 °C (right, having a dark chocolate color).

FIG. 10 is a photograph of hot milk with vitamins after the initial addition of an illustrative composition thereto (left, having a strawberry/pink color) and after mixing (right, having a light orange/mango color).

FIG. 11 is a photograph of an energizing drink having blueberry flavor, green bean coffee and guarana after the initial addition of an illustrative composition thereto (left, having a reddish/purple color on top and a pink color on bottom), after mixing (middle, having a purple color), and after heating to at least 50 °C (right, having a pink color).

FIG. 12 is a photograph of an energizing drink having pomegranate flavor, acerola (vitamin C) and Panax ginseng after the initial addition of an illustrative composition thereto (left, having a reddish/purple color on top and a pink color on bottom), after mixing (middle, having a purple color), and after heating to at least 50 °C (right, having a pink color).

FIG. 13 is a photograph of cold milk after the initial addition of an illustrative composition having a coffee flavor thereto (left, having a blue color) and after heating to at least 50 °C (right, having a pink color).

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The present disclosure relates to the surprising finding that the addition of the disclosed composition to consumables makes it possible to provide a variety of different color changes to consumables in a predictable and controlled manner.

The term “color” refers to the color properties such as hue, chroma, purity, saturation, intensity, vividness, value, lightness, brightness and darkness, and color model system parameters used to describe these properties, such as Commission Internationale de l'Eclairage CIE 1976 CIELAB color space L*a*b* values. The term “hue” refers to the color property that gives a color its name, for example, red, blue and brown.

Colorants are substances that are added or applied to change the color of a material, in this case consumables. Colorants used in the present disclosure include natural colorants and synthetic colorants. According to certain illustrative embodiment, the colorants are food grade natural colorants.

In certain embodiments, disclosed is a composition for effecting color change in a consumable, wherein the composition comprises a first color delivery system comprising first core particles at least partially coated with a first colorant, and wherein the at least partially coated first core particles are at least partially encapsulated by a first encapsulant. In certain embodiments, the first core particles are completely coated by a first encapsulant. In certain embodiments, the at least partially coated first core particles are completely encapsulated by a first encapsulant.

In certain embodiments, disclosed is a composition for effecting color change of a consumable, wherein the composition comprises a first color delivery system comprising first core particles at least partially coated with a first colorant, and wherein the at least partially coated first core particles are at least partially encapsulated by a first encapsulant; and a second color delivery system comprising second core particles at least partially coated with a second colorant comprising a color that is different from the color of the first colorant, and wherein the at least partially coated second core particles are at least partially encapsulated by a second encapsulant, wherein the first encapsulant is the same or different from the second encapsulant. In certain embodiments, the first encapsulant is different from the second encapsulant. In certain embodiments, the first encapsulant has the same or different dissolution properties than the second encapsulant. In certain embodiments, the composition comprises one or more additional color delivery systems that are different than the first and second color delivery systems disclosed herein, for example, the one or more additional color delivery systems may contain a colorant that is different than the colorants included in the first and/or second color delivery systems.

In certain embodiments, the first and second core particles are spherical or substantially spherical, free-flowing, mechanically stable particulates. The term “spherical” as used herein refers to core particles having a bead-like or a substantially bead-like appearance upon visual observation with the naked eye. The phrases “substantially spherical” or “substantially bead-like” refers to core particles having a substantially circular or oval cross-section and appearing as round to roundish particles with the naked eye.

By “core particle”, it is meant a particulate material that is coated with a colorant, or coated with a carbohydrate matrix comprising a colorant. Unless otherwise stated, the phrase “core particles” as used herein may refer to the first color delivery system, the second color delivery system, and/or one or more additional color delivery systems. The core particles may absorb part of the colorant included in the composition and facilitate its delayed release. The number and size of core particles present is not particularly critical, provided the particle size requirements of the final consumable are met.

The core particles may be any such material known to the art that can be produced at or reduced to the desired size for use in compositions. In certain embodiments, the core particles are a solid having a particle size of from about 0.02 mm to about 3 mm. In certain embodiments, the core particles are a solid having a particle size of from about 0.2 mm to about 1.5 mm. In certain embodiments, the core particles are a solid having a particle size of from about 0.2 mm to about 1 mm.

The core particles may be in the form of spray dried particles. For example, a spray dried particle may be formed by preparing a solution of suitable material and spray drying the solution according to techniques known in the art. In certain embodiments, the core particles may be in the form of microparticles. In certain embodiments, the core particles may be provided in the form of a particulate consisting of a grain of material such as an acidulent, e.g., citric acid, or a sugar.

In certain embodiments, the core particles are any particulate material which is inert under fluidized bed conditions. In certain embodiments, the core particles comprise at least one of: a carbohydrate, e.g. a sugar such as glucose, lactose, sucrose, or also a product of more complex composition such as fruit powder, e.g. orange juice powder, or vegetable powder, e.g. carrot juice powder, or a sugar alcohol such as isomaltol, sorbitol or pectin, hydrolyzed vegetable protein (HVP), food fibres, e.g. husks, wheat fibres, cellulose fibres, etc., or an organic or inorganic salt, e.g. a citric acid salt or sodium chloride, herb powder, spice powder, tea powder, or combinations thereof.

In certain embodiments, the core particles comprise a carbohydrate, fruit powder, vegetable powder, pectin, hydrolyzed vegetable protein (HVP), plant seeds like sesame seeds, edible fiber, sugar alcohol, organic or inorganic salts, a flavorant, or mixtures thereof. In certain embodiments, the core particles comprise a carbohydrate selected from glucose, lactose, sucrose, starch, degraded starch or combinations thereof. In certain embodiments, the core particles comprise sucrose.

In certain embodiments, the core particles consist essentially of, or consist of, sucrose. In certain embodiments, the core particles comprise a sugar alcohol selected from the group consisting of erythritol, xylitol, mannitol, sorbitol, isomalt, inositol, pectin and combinations thereof. In certain embodiments, the core particles comprise sorbitol. In certain embodiments, the edible fiber is selected from husks, wheat fibers, cellulose fibers, and combinations thereof.

In certain embodiments, the core particles, an aqueous solution comprising one or more colorants, and/or a carbohydrate matrix comprising one or more colorants, may comprise at least one flavorant. By “flavorant” it is meant a composition created by a flavorist using methods known to the skilled person that is a mixture of tastants, aroma compounds and sensates. Examples of suitable flavorants include natural flavors, artificial flavors, spices, seasonings, and the like. Exemplary flavorants include synthetic flavor oils and flavoring aromatics and/or oils, oleoresins, essences, and distillates, and a combination comprising at least one of the foregoing.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavors imparted by a flavorant include a milk flavor, a butter flavor, a cheese flavor, a cream flavor, and a yogurt flavor, a vanilla flavor, tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; floral flavors; and vegetable flavors, such as an onion flavor, a garlic flavor, a cabbage flavor, a carrot flavor, a celery flavor, mushroom flavor, and a tomato flavor.

According to some embodiments, flavorants may also include aldehydes and esters such as cinnamyl acetate, cinnamaldehyde, citral diethylacetal, dihydrocarvyl acetate, eugenyl formate, p-methylamisol, and so forth can be used. Further examples of aldehyde flavourings include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavours), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like.

Generally, any flavorant or food additive such as those described in “Chemicals Used in Food Processing”, Publication No 1274, pages 63-258, by the National Academy of Sciences, can be used. This publication is incorporated herein by reference.

The core particles disclosed herein may contain other optional excipients, including, but not limited to fillers, flavorants and the like.

In certain embodiments, the core particles have a bulk density of from 0.2-2.0 g/cm³, more particularly from 0.2-1.5 g/cm³, 0.5-1.2 g/cm³ and 0.8-1.2 g/cm³.

The core particles may have a narrow grain-size distribution according to embodiments wherein the core particles are at least partially encapsulated in a carbohydrate matrix, as described herein. The narrow particle size distribution can be achieved by the combined effects of the parameters: the core particle size; composition of the matrix; spray rate of the matrix; the rate of rotation of the rotating base plate; the air inlet velocity; and the air temperature. The manner in which the granulation is carried out is well-known to a person skilled in the art and the narrow distribution can be determined by routine experimentation.

In certain embodiments, the core particles are present in an amount of from about 40 to about 95% by weight, based on the total weight of the composition. In certain embodiments, the core particles are present in an amount of from about 50 to about 90% by weight, based on the total weight of the composition. In certain embodiments, the core particles are present in an amount of from about 55 to about 85% by weight, based on the total weight of the composition. In certain embodiments, the core particles are present in an amount of from about 60 to about 80% by weight, based on the total weight of the composition. In certain embodiments, the core particles are present in an amount of from about 65 to about 75% by weight, based on the total weight of the composition.

As used herein, a “colorant” is any substance that imparts colour by absorbing or scattering light at different wavelengths or modifies the color of a consumable. A “food-grade colorant” refers to a colorant suitable for use in a food product intended for human or animal consumption, and is differentiated from a nontoxic material that may provide color, but is generally not included in a food product or is only included in a trace amount. Colorant may be used in pure form or in the form of an oleoresin, an extract or a powder. As used herein, the term “natural colourant” refers to a pigment that can be found in natural sources, including plants, algae, fungi and the like. It is to be understood that the natural colorant of the present invention can be derived from a natural source or can be synthesized chemically. Examples of colorants include but are not limited to carotenoids, vegetable juice concentrate, anthocyanin containing colorants, phycobilin containing colorants, betain containing colorants, betalain containing colorants, or mixtures thereof.

In certain embodiments, at least one colorant is present in an amount of from about 0.5 to about 30% by weight, based on the total weight of the composition. In certain embodiments, at least one colorant is present in an amount of from about 1 to about 25% by weight, based on the total weight of the composition. In certain embodiments, at least one colorant is present in an amount of from about 2 to about 20% by weight, based on the total weight of the composition.

In certain embodiments, at least one colorant is present in an amount of from about 3 to about 15% by weight, based on the total weight of the composition. In certain embodiments, at least one colorant is present in an amount of from about 4 to about 10% by weight, based on the total weight of the composition.

In certain embodiments, the composition comprises one or more non-encapsulated colorants. In certain embodiments, the one or more non-encapsulated colorants comprise a color different than the color of the first color delivery system and/or the second color delivery system disclosed herein. In certain embodiments, the non-encapsulated colorant comprises a color that is the same as the color of the first color delivery system and/or the second color delivery system disclosed herein. In certain embodiments, a non-encapsulated colorant is present in an amount of from about 0.5 to about 30% by weight, based on the total weight of the composition. In certain embodiments, a non-encapsulated colorant is present in an amount of from about 1 to about 25% by weight, based on the total weight of the composition. In certain embodiments, a non-encapsulated colorant is present in an amount of from about 2 to about 20% by weight, based on the total weight of the composition. In certain embodiments, a non-encapsulated colorant is present in an amount of from about 3 to about 15% by weight, based on the total weight of the composition. In certain embodiments, a non-encapsulated colorant is present in an amount of from about 4 to about 10% by weight, based on the total weight of the composition.

The terms “a” and “an” are defined as one or more unless expressly stated otherwise or constrained by other language herein. An element or feature proceeded by “a” or “an” may be interpreted as one of the recited elements or features, or more than one of the elements or features.

Without limitation, colorants may include lactoflavin (riboflavin), chlorophyllin, carotenoids, xanthophylls (e.g. lutein and/or zeaxanthin), phycobiliproteins (e.g. phycoerythrin, allophycocyanin) phycocyanin, beta-carotene, riboflavin-5′-phosphate, alpha-carotene, gamma-carotene, cantaxanthin, erythrosine, curcumin, quinoline yellow, yellow orange S, tartrazine, bixin, norbixin (annatto, orlean), capsanthin, capsorubin, lycopene, beta-apo-8′-carotenal, beta-apo-8′-carotenic acid ethyl ester, xantophylls (flavoxanthin, lutein, cryptoxanthin, rubixanthin, violaxanthin, rodoxanthin), fast carmine (carminic acid, cochineal), azorubin, cochineal red A (Ponceau 4 R), beetroot red, betanin, anthocyanins, amaranth, patent blue V, indigotine I (indigo-carmine), chlorophylls, copper compounds of chlorophylls, acid brilliant green BS (lissamine green), brilliant black BN, vegetable carbon, titanium dioxide, iron oxides and hydroxides, calcium carbonate, aluminum, silver, gold, pigment rubine BK (lithol rubine BK), methyl violet B, victoria blue R, victoria blue B, acilan brilliant blue FFR (brilliant wool blue FFR), naphthol green B, acilan fast green 10 G (alkali fast green 10 G), ceres yellow GRN, sudan blue II, ultramarine, phthalocyanine blue, phthalocayanine green, fast acid violet R. Paprika extract, black carrot extract, and red cabbage extract can also be used.

In certain embodiments, the colorant comprise natural colorants selected from the group consisting of anthocyanins (e.g., cyanidin, peonidin, malvidin, delphinidin, petunidin, pelargonidin), allophycocyanins, betalains, curcumin, chlorophylls, lycopenes, phycocyanins, anthocyanins, carotenoids, and mixtures thereof. The colorants may be produced via fermentation followed by water extraction from a suitable microalgae.

Betalains are a class of water-soluble red and yellow tyrosine-derived pigments found in plants of the order Caryophyllales, where they replace anthocyanin pigments. There are two categories of betalains:
a) Betacyanins, which appear reddish to violet. Examples of betacyanins present in plants include betanin, isobetanin, probetanin, and neobetanin; and
b) Betaxanthins, which appear yellow to orange. Betaxanthins present in plants include vulgaxanthin, miraxanthin, portulaxanthin, and indicaxanthin.

The betalains used in the present invention may be betacyanins, such as betanin, isobetanin, probetanin, and neobetanin; and/or betaxanthins, such as vulgaxanthin, miraxanthin, portulaxanthin, and indicaxanthin. In one embodiment, the betalain is a beetroot derived color. Optionally, the betalain used in the present invention may be betanin.

Phycocyanins are water-soluble pigments that can provide a true blue color without any purple or green undertones. Phycocyanins can be extracted from microalgae and provide shades from pastel to vibrant blues. A suitable phycocyanin-rich colorant active can be obtained from the microalgae Galdieria sulphuraria and Spirulina (Arthrospira platensis) which occurs naturally in freshwater and marine habitats.

Phycobilins are light-harvesting pigments found in cyanobacteria, but they are not present in higher plants. The fundamental structure of phycobilins consists of a tetrapyrrole unit, in which the four pyrrole rings form an open chain. There are four major phycobilins in photosynthetic organisms, phycoerythrobilin, phycocyanobilin, phycoviolobilin and phycourobilin. Differences in the extent of m-electron conjugation are responsible for the distinct absorption spectral properties and coloration of the chromophores. Phycoerythrobilin appears red, phycocyanobilin is blue, phycoviolobilin is purple, and phycourobilin is yellow colored. In one embodiment, the phycobilin may be present as an extract obtained or obtainable from a cyanobacteria from the Arthrospira platensis, A. fusiformis, or A. maxima species. Optionally, the phycobilin may be obtained or obtainable from Arthrospira platensis (spirulina).

In one embodiment, the phycobilin is a spirulina derived color. Optionally, the phycobilin in the present invention may be phycocyanobilin, which has a blue color.

In one embodiment, the betalain may be present as an extract obtained or obtainable from a plant from the Amaranthaceae family. Optionally, the plant from the Amaranthaceae family may be Beta vulgaris (beet).

Chlorophyll is a green pigment ubiquitous in nature where it is found in the chloroplasts of plants and algae and cyanobacteria. It is an essential part of photosynthesis, the process in which these organisms convert light into chemical energy. When originally extracted it is in an oil soluble form called chlorophyll but can be converted into a water-soluble version called chlorophyllin.

Anthocyanins are glycosides of the sugar-free anthocyanidins (the aglycone). The sugar molecules in anthocyanins are bound via O-glycosidic bonds to one or more of the hydroxy groups typically present in an anthocyanidin molecule. Most naturally occurring anthocyanins are

3-O-glycosides. Anthocyanins are water soluble natural pigments responsible for the pink, red, purple, and blue hues of many flowers and edible fruits. In certain embodiments, the anthocyanin is obtained from purple corn, purple carrots, red radish, elderberry, cabbage, purple sweet potato and mixtures thereof. Other sources like cabbage and purple sweet potato can also be used. Anthocyanins are unique compared to other natural colors because the molecule slightly shifts in structure based on the pH that it is in, causing it to change colors from pink/red in lower pH levels to purple/blue in neutral/high pH levels. Anthocyanin may be present as an extract obtained or obtainable from a plant from the Brassicaceae family (such as Raphanus sativus L. (red radish)), the Rosaceae family (such as Fragaria (strawberry)), the Solanaceae family (such as Solanum tuberosum (red potato)), the Convolvulaceae family (such as Ipomoea batatas (purple sweet potato root)), the Apiaceae family (such as Daucus carota ssp. sativus var. atrorubens Alef. (black carrot)) or mixtures thereof.

Carotenoids, also called tetraterpenoids, are yellow, orange, and red organic pigments that are produced by plants and algae, as well as several bacteria, and fungi. Carotenoids give the characteristic colour to pumpkins, carrots, corn, tomatoes, canaries, flamingos, salmon, lobster, shrimp, and daffodils. In one embodiment, the carotenoids are a carrot derived color. In one embodiment, the carotenoids are a Dunalliela derived color.

Cochineal and carmine are natural colors extracted from the cactus-dwelling female cochineal insect that is native to Latin America. Depending on the method of extraction, it can range in hue from orange to red to purple.

Curcumin, also referred to as turmeric, is a vibrant yellow pigment extracted from the root of the turmeric plant, which is in the ginger family.

In certain embodiments, the composition comprises a first color delivery system comprising first core particles at least partially coated with a first colorant, wherein the first colorant comprises betanin obtained from beetroot or phycobilin obtained from Arthrospira platensis (spirulina), and a second color delivery system comprising second core particles at least partially coated with a second colorant, wherein the second colorant comprises betanin obtained from beetroot or phycobilin obtained from Arthrospira platensis (spirulina)

In certain embodiments, the first encapsulant that at least partially encapsulates the first colorant coated first core particles delays the release of the first colorant from the first color delivery system under specific conditions, such as passage of time, temperature, shear forces, pH, or combinations thereof.

In certain embodiments, the second encapsulant that at least partially encapsulates the second colorant coated second core particles delays the release of the second colorant from the second color delivery system under specific conditions, such as passage of time, temperature, shear forces, pH, or combinations thereof.

The first encapsulant may exhibit the same or different dissolution properties as the second encapsulant. In certain embodiments, the first encapsulant has the same or substantially the same dissolution properties as the second encapsulant. In certain embodiments, the first encapsulant has different dissolution properties from the second encapsulant. Altering the dissolution properties of the encapsulants disclosed herein can be achieved by a number of means. For example, the first encapsulant and the second encapsulant may be composed of material having different melting points or dissolution properties. The size or thickness of the first encapsulant and the second encapsulant can also be modified to achieve a desired release rate of different colors, for example, different colors may be released at the same or different period of times after being added to a consumable. A batch type fluid bed process may be utilized wherein a higher amount of the first encapsulant material is applied over time, as compared to the amount of second encapsulant material applied over time. The longer spraying time of the first encapsulant results in an increased thickness, as compared to the thickness of the second encapsulant. This results in the first colorant included in the first color delivery system having a more delayed release than the second colorant included in the second color delivery system.

In certain embodiments, the first encapsulant and the second encapsulant have different temperature dependent dissolution properties and therefore release their respective encapsulated colorants under different temperature conditions. The first encapsulant and the second encapsulant can be composed of a wide variety of material, depending upon the specific application and the desired color change and the desired delayed release rate.

In certain embodiments, the first encapsulant that at least partially encapsulates the first colorant coated first core particles and/or the second encapsulant that at least partially encapsulates the second colorant coated second core particles is a carbohydrate that is water soluble at temperatures of 50 °C or less, 45 °C or less, 40 °C or less, 35 °C or less, 30 °C or less, 25 °C or less, 20 °C or less, or any combinations thereof.

In certain embodiments, the first encapsulant that at least partially encapsulates the first colorant coated first core particles and/or the second encapsulant that at least partially encapsulates the second colorant coated second core particle is a fat having a melting point of at least about 50 °C, at least about 55 °C, at least about 58 °C, at least about 60 °C, at least about 61 °C, at least about 62 °C, or at least about 65 °C. The melting point depends on the type of fat used.

In certain embodiments, the first encapsulant and/or the second encapsulant comprises a fat, a wax, a cellulose derivative, or mixtures thereof. In certain embodiments, the first encapsulant and/or the second encapsulant does not contain gelatin. In certain embodiments, the first encapsulant and/or the second encapsulant is water insoluble at a temperature above 20 °C, 30 °C, or 40 °C. In certain embodiments, the first encapsulant and/or the second encapsulant is water insoluble at a temperature above 50 °C, 55 °C, or 60 °C.

In certain embodiments, the first encapsulant and/or the second encapsulant comprises a fat or a carbohydrate. In certain embodiments, the carbohydrate comprises a cellulose derivative. In certain embodiments, the cellulose derivative comprises an alkyl cellulose. In certain embodiments, the alkyl cellulose comprises methyl cellulose. In certain embodiments, the cellulose derivative is selected from the group consisting of methylcellulose, ethylcellulose, hydroxy ethylcellulose, hydroxypropylcellulose, hydroxy propyl methylcellulose, carboxymethylcellulose, and mixtures thereof.

In certain embodiments, the first encapsulant and/or the second encapsulant is thermoreversible, which can form thermally reversible gels. As used herein, the term “thermoreversible” refers to a physical property of the first encapsulant, the second encapsulant and/or additional encapsulants in which the encapsulant can undergo a physical change of a solid-gel state to a liquid state repeatedly when exposed to different temperatures. For example, an encapsulant may remain as a solid at temperatures of about 40 °C or greater and converts to a liquid at temperatures below about 40 °C, and the encapsulant can become solid again when the temperature increases again to about 40 °C or greater. The gelling temperature depends on the type and the concentration of the encapsulant in water. Thermoreversible material for use herein can be selected from methyl cellulose, hydroxypropyl cellulose, hydroxypropyl methyl cellulose, ethyl methyl cellulose, ethyl cellulose and mixture thereof. The thermoreversible encapsulant may be present in an amount of from about 1% to about 20%, or from about 5% to about 15%, or from about 5 to about 10% by weight of the composition.

In certain embodiments, the first encapsulant and/or the second encapsulant comprises a fat or wax having a melting point such that it softens or melts at a temperature of at least 50 °C, or at least about 55 °C, or at least about 59 °C, or at least about 61 °C, or at least about 65 °C, or at least about 68 °C. The term “fat” as used herein encompasses triglycerides, sucrose polyesters of fatty acids and combinations thereof. High melting fat in accordance with the present disclosure may be obtained by hydrogenation of vegetable oils and/or animal fats, or by isolating high melting fractions from these oils and fats.

The fat may be a lipophilic fatty acid residue containing materials such as triglycerides, diglycerides, monoglycerides, phosphatides and sucrose fatty acid polyesters. In particular, the fats may be triglycerides. In certain embodiments, the fat comprises a hydrogenated vegetable oil selected from the group consisting of almond oil, avocado oil, canola oil, coconut oil, corn oil, cottonseed oil, flaxseed oil, hazelnut oil, illipe oil, linseed oil, palm oil, palm kernel oil, peanut oil, pecan oil, pumpkin seed oil, oat oil, olive oil, rapeseed oil, safflower oil, sesame oil, shea oil, soybean oil, sunflower oil, walnut oil, and mixtures thereof. In certain embodiments, the fat comprises hydrogenated rapeseed oil. The wax may be carnauba wax.

The first encapsulant and/or the second encapsulant may contain other optional excipients, including, but not limited to fillers, plasticizers, extenders and the like.

In certain embodiments, the first encapsulant and/or the second encapsulant is present in an amount of from about 0.5 to about 50% by weight, based on the total weight of the composition. In certain embodiments, the first encapsulant and/or the second encapsulant is present in an amount of from about 1 to about 40% by weight, based on the total weight of the composition. In certain embodiments, the first encapsulant and/or the second encapsulant is present in an amount of from about 3 to about 30% by weight, based on the total weight of the composition. In certain embodiments, the first encapsulant and/or the second encapsulant is present in an amount of from about 5 to about 25% by weight, based on the total weight of the composition. In certain embodiments, the first encapsulant and/or the second encapsulant is present in an amount of from about 7 to about 20% by weight, based on the total weight of the composition. In certain embodiments, the first encapsulant and/or the second encapsulant is present in an amount of from about 9 to about 16% by weight, based on the total weight of the composition. In certain embodiments, the first encapsulant and/or the second encapsulant is present in an amount of from about 10 to about 15% by weight, based on the total weight of the composition.

In certain embodiments, the composition includes one or more additional encapsulants, present in the above disclosed amounts, that are the same or different than the first and second encapsulants disclosed herein.

In certain embodiments, the first colorant and/or the second colorant are at least partially encapsulated in a carbohydrate matrix. The carbohydrate matrix may comprise a modified starch, a sugar alcohol, a gum, a protein, a plant extract, a cellulose derivative, or mixtures thereof.

In certain embodiments, the modified starch comprises maltodextrin. In certain embodiments, the carbohydrate matrix is an emulsion. Exemplary gums include, but are not limited to, xanthan gum, guar gum, acacia gum, arabic gum, and mixtures thereof. In certain embodiments, the gum comprises acacia gum. In certain embodiments, the carbohydrate matrix comprises gum acacia, maltodextrin and sorbitol.

Also disclosed is a beverage powder mix comprising a first color delivery system comprising first core particles at least partially coated with a first colorant, and wherein the at least partially coated first core particles are at least partially encapsulated by a first encapsulant; and a second color delivery system comprising second core particles at least partially coated with a second colorant comprising a color that is different from the color of the first colorant, and wherein the at least partially coated second core particles are at least partially encapsulated by a second encapsulant, wherein the powder mix changes the color of a beverage over a period of time in response to temperature, mechanical agitation, passage of time, or combinations thereof, when the powder mix is added to the beverage.

The compositions according to the present disclosure can be produced by any suitable process, according to which a coating is fixed on core particles, for instance performed in a tumbler, spray dried, or a fluidized bed process, such as continuous fluidized bed spray granulation. In certain embodiments, an aqueous solution containing the first colorant or the second colorant is sprayed onto core particles fluidized in a fluidized bed rotor-granulator. In certain embodiments, an aqueous solution containing the first colorant is sprayed onto the first core particles fluidized in a fluidized bed rotor-granulator, and an aqueous solution containing the second colorant is sprayed onto the second core particles fluidized in the same or different fluidized bed rotor-granulator.

Typical fluidized bed equipment include Wurster, rotor granulator and top spray systems. The fluidized bed equipment is operated according to the normal practices and within the recognized parameters of the art. Suitable equipment such as the Glatt ProCell Labsystem equipped with a rotor granulator insert is commercially available from The Glatt Group (Binzen, Germany), and has the following typical operating conditions:
Inlet temperature 60-110 °C, particularly about 95 °C,
Product Temperature 35-90 °C, particularly about 65 °C,
Air flow rate 20-140 m³/h, particularly about 60 m³/h,
Nozzle air pressure 0.5-6 bar, particularly about 4 bar.

The process may be carried out by spraying a solution, emulsion or melt containing at the first colorant in water into the fluidized bed agglomerator, which has previously been charged with a quantity of first core particles. The first core particles onto which the solution, emulsion or melt is sprayed can also be particulate material selected from a sugar or sugar alcohol. The solution, emulsion or melt containing the first colorant coats the first core particles fluidized by the passage of air through the bed and causes some agglomeration of the first core particles and a build-up of the components of the solution, emulsion or melt including the first colorant. The first encapsulant is thereafter sprayed on the color coated first core particles to at least partially encapsulate the first colorant coated first core particles. Since the residence time in the fluidized bed is controllable, the spraying of i) the solution, emulsion or melt containing the first colorant and/or the ii) the solution, emulsion or melt containing the first encapsulant may be continued until the required particle size has been obtained, or until the desired controlled release properties are achieved. For example, the spraying of the first encapsulant may be continued until the controlled release property of the composition is at least 1 minute, at least 2 minutes, at least 3 minutes, at least 4 minutes, or at least 5 minutes, or any desired release rate. The same process may be carried out to form second core particles coated with a second colorant and thereafter encapsulated with a second encapsulant, wherein the first colorant is different than the second colorant.

A suitable apparatus comprises a fluidized bed apparatus and an arrangement for supplying and extracting air. The apparatus may be a cylindrical vessel having a vertical rotating axis, the base of which rotates around the central axis. The cylinder casing is typically fixed. The rate of rotation is typically about 50-500/min. The core particles provided in the process are set in motion by means of a rotating base plate. A relatively small amount of air passes through the (peripheral) annular clearance between the rotating base plate and fixed vessel wall and this together with the rotational motion of the base plate sets the core particles in motion, i.e. “fluidizes”.

In certain embodiments, the method of fluidized bed spray granulation can be carried out at elevated air temperatures in the range from 40 °C to 180 °C, preferably from 80 °C to 140 °C. The permissible product temperature is linked to the exhaust air temperature and is set via the spray rate of the spray solution.

In certain embodiments, the composition is produced by the following steps:
a) forming a first color delivery system by forming a solution, emulsion or melt containing the first colorant;
b) introducing the solution, emulsion or melt of step (a) into a fluidized bed comprising first core particles and using an inlet air temperature of 40-120 °C, preferably 60-100 °C, to obtain a stable core particle coated with the first colorant;
c) forming a solution, emulsion or melt containing an encapsulant;
d) introducing the solution, emulsion or melt of step (c) into the fluidized bed comprising the first colorant-coated core particles and using an inlet air temperature of 40-120 °C, preferably 60-100 °C, to obtain encapsulated first colorant-coated core particles; and
e) optionally forming a second color delivery system by repeating steps a)-d) with second core particles, second colorant and second encapsulant.
f) optionally forming one or more additional color delivery systems by repeating steps a)-e) with core particles, at least one colorant and an encapsulant.

In certain embodiments, the composition is produced by the following steps:
a) forming a first color delivery system by forming a carbohydrate matrix solution, emulsion or melt containing the first colorant;
b) introducing the carbohydrate matrix solution, emulsion or melt of step (a) into a fluidized bed comprising first core particles and using an inlet air temperature of 40-120 °C, preferably 60-100 °C, to obtain a stable first core particle coated with the carbohydrate matrix; and
c) forming a solution, emulsion or melt containing the first encapsulant;
d) introducing the solution, emulsion or melt of step (c) into the fluidized bed comprising the color-coated first core particles and using an inlet air temperature of 40-12 °C., preferably 60-100 °C, to obtain encapsulated first colorant-coated core particles; and and
e) optionally forming a second color delivery system by repeating steps a)-d) with second core particles, second colorant and second encapsulant.
f) optionally forming one or more additional color delivery systems by repeating steps a)-e) with core particles, at least one colorant and an encapsulant.

The composition of the present disclosure may be used in a wide variety of consumables or applications and is not restricted to any particular physical mode or product form. According to the present disclosure, the term “consumable” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, syrups, aerosols and sprays. The term also refers to, for example, dietary and nutritional supplements. Consumables include compositions that are placed within the oral cavity for a period of time before being discarded but not swallowed. It may be placed in the mouth before being consumed, or it may be held in the mouth for a period of time before being discarded.

Broadly, consumables include, but are not limited to, foodstuffs of all kinds, confectionery products, baked products, sweet products, savoury products, fermented products, dairy products, beverages, oral care products, nutraceuticals and pharmaceuticals.

Exemplary foodstuffs include, but are not limited to, chilled snacks, sweet and savoury snacks, fruit snacks, chips/crisps, extruded snacks, tortilla/corn chips, popcorn, pretzels, nuts, other sweet and savoury snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, meat analogs, frozen pizza, chilled pizza, soup, canned soup, dehydrated soup, instant soup, chilled soup, UHT soup, frozen soup, pasta, canned pasta, dried pasta, chilled/fresh pasta, noodles, plain noodles, instant noodles, cups/bowl instant noodles, pouch instant noodles, chilled noodles, snack noodles, dried food, dessert mixes, sauces, dressings and condiments, herbs and spices, spreads, jams and preserves, honey, chocolate spreads, nut-based spreads, and yeast-based spreads.

Exemplary confectionery products include, but are not limited to, chewing gum (which includes sugarized gum, sugar-free gum, functional gum and bubble gum), centerfill confections, chocolate and other chocolate confectionery, medicated confectionery, lozenges, tablets, pastilles, mints, standard mints, power mints, chewy candies, hard candies, boiled candies, breath and other oral care films or strips, candy canes, lollipops, gummies, jellies, fudge, caramel, hard and soft panned goods, toffee, taffy, liquorice, gelatin candies, gum drops, jelly beans, nougats, fondants, combinations of one or more of the above, and edible flavour compositions incorporating one or more of the above.

Exemplary baked products include, but are not limited to, alfajores, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savoury biscuits and crackers, bread substitutes.

Exemplary sweet products include, but are not limited to, breakfast cereals, ready-to-eat (“rte”) cereals, family breakfast cereals, flakes, muesli, other ready to eat cereals, children's breakfast cereals, hot cereals.

Exemplary savoury products include, but are not limited to, salty snacks (potato chips, crisps, nuts, tortilla-tostada, pretzels, cheese snacks, corn snacks, potato-snacks, ready-to-eat popcorn, microwaveable popcorn, pork rinds, nuts, crackers, cracker snacks, breakfast cereals, meats, aspic, cured meats (ham, bacon), luncheon/breakfast meats (hotdogs, cold cuts, sausage), tomato products, margarine, peanut butter, soup (clear, canned, cream, instant, ultrahigh temperature “UHT”), canned vegetables, pasta sauces.

Exemplary dairy products include, but are not limited to, cheese, cheese sauces, cheese-based products, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavoured, functional and other condensed milk, flavoured milk drinks, dairy only flavoured milk drinks, flavoured milk drinks with fruit juice, soy milk, sour milk drinks, fermented dairy drinks, coffee whiteners, powder milk, flavoured powder milk drinks, cream, yoghurt, plain/natural yoghurt, flavoured yoghurt, fruited yoghurt, probiotic yoghurt, drinking yoghurt, regular drinking yoghurt, probiotic drinking yoghurt, chilled and shelf-stable desserts, dairy-based desserts, soy-based desserts.

Exemplary beverages include, but are not limited to, flavoured water, soft drinks, fruit drinks, coffee-based drinks, tea-based drinks, juice-based drinks (includes fruit and vegetable), milk-based drinks, gel drinks, carbonated or non-carbonated drinks, powdered drinks, alcoholic or non-alcoholic drinks, and ready to drink liquid formulations of these beverages. Compositions comprising particles of the present invention can be easily filled into “stick packs” or sachets. Stick packs, typically elongate tubular packaging that is sealed at both ends have become popular in the packaging industry for foods and beverages.

Exemplary fermented foods include, but are not limited to, cheese and cheese products, meat and meat products, soy and soy products, fish and fish products, grain and grain products, fruit and fruit products.

In certain embodiments, a consumable may include an initial color, pigment and/or tint before the disclosed composition is added thereto. In certain embodiments, a consumable may contain no or substantially no initial color, pigment and/or tint, i.e., the consumable is colorless or substantially colorless, before the disclosed composition is added thereto.

Also disclosed is a process for changing the color of a consumable, wherein the process comprises providing the disclosed composition to a consumable and
i) changing the temperature of the consumable to a predetermined temperature that is sufficient to release the first colorant,
ii) mixing the consumable for a predetermined period of time that is sufficient to release the first colorant, and/or
iii) allowing the consumable to sit for a predetermined period of time that is sufficient to release the first colorant.

In certain embodiments, the composition is a beverage composition in the form of a powdered soft drink or beverage or a dry mix composition. In certain embodiments, the composition is added to a beverage as a powder. In certain embodiments, the composition is in the form of a powder packaged in a stick pack.

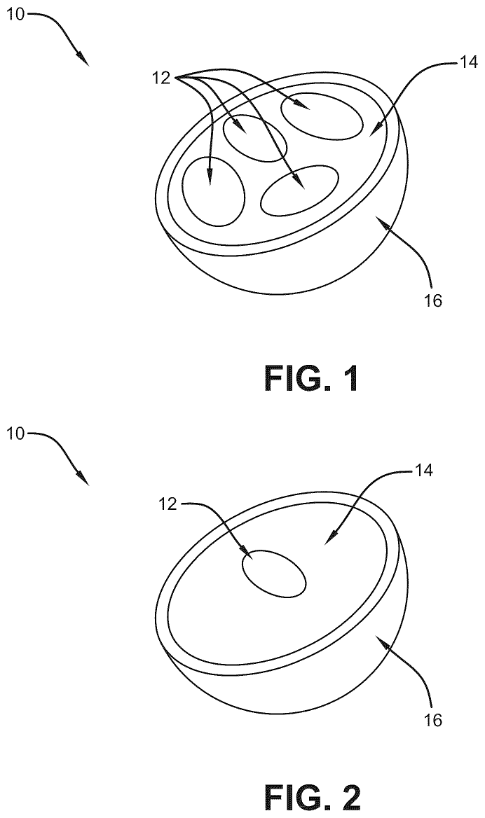

The disclosed composition is readily understood when read in conjunction with illustrative FIGS. 1-13. It should be noted that the composition is not limited to any of the illustrative embodiments shown in the figures, but rather should be construed in breadth and scope in accordance with the disclosure provided herein.

FIG. 1 is a schematic cross-sectional view of an illustrative composition 10 for effecting color change of a consumable (not shown), wherein composition comprises first color delivery system 10 comprising a plurality of first core particles 12 coated with first colorant 14, wherein first core particles 12 and first colorant 14 are encapsulated by first encapsulant 16.

FIG. 2 is a schematic cross-sectional view of an illustrative composition comprising first color delivery system 10 for effecting color change of a consumable (not shown), wherein first color delivery system 10 comprises a single first core particle 12 coated with first colorant 14, and wherein single first core particle 12 and first colorant 14 are encapsulated by first encapsulant 16.

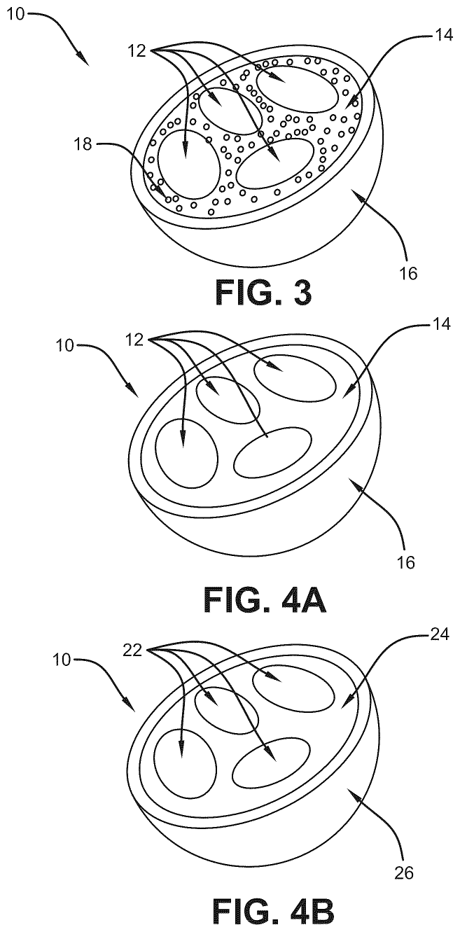

FIG. 3 is a schematic cross-sectional view of an illustrative composition comprising first color delivery system 10 for effecting color change of a consumable (not shown), wherein first color delivery system 10 comprises first core particles 12 coated with first colorant 14 and flavorant 18, and wherein first core particle 12, first colorant 14, and flavorant 18 are encapsulated by first encapsulant 16.

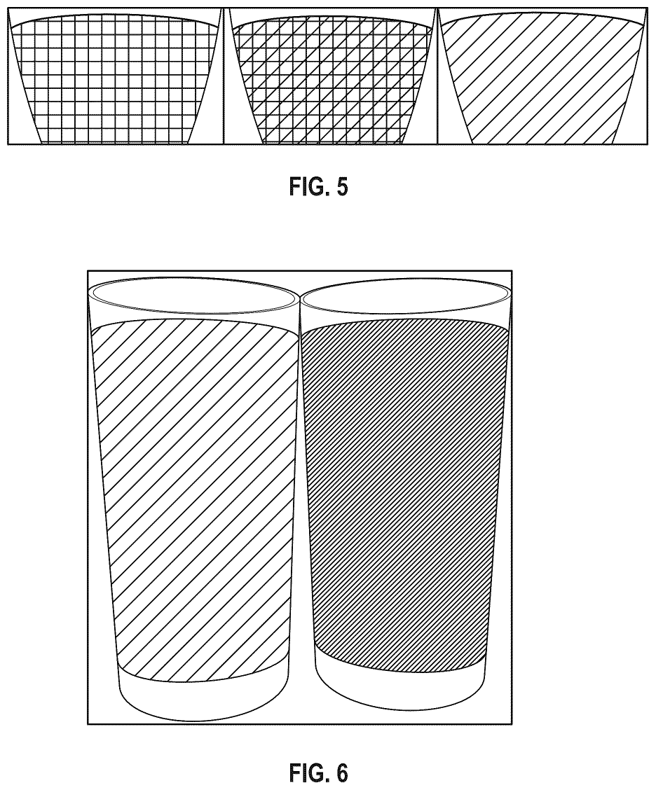

FIG. 4A is a schematic cross-sectional view of an illustrative composition comprising first color delivery system 10 for effecting color change of a consumable (not shown), wherein first color delivery system 10 comprises first core particles 12 coated with first colorant 14, and wherein first core particles 12 and first colorant 14 are encapsulated by a first encapsulant 16 comprising a carbohydrate.

FIG. 4B is a schematic cross-sectional view of an illustrative composition comprising second color delivery system 10 for effecting color change of a consumable (not shown), wherein second color delivery system 10 comprises second core particles 22 coated with second colorant 24, and wherein second core particles 22 and second colorant 24 are encapsulated by a second encapsulant 26 comprising a fat having a melting point of at least 50 °C.

FIG. 5 is a photograph of cold milk (from about 0 °C to about 5 °C) after the initial addition of an illustrative composition thereto (left, having a banana yellow color), after 1 minute of stirring (middle, having a chocolate/banana color), and after mixing (right, having a chocolate color), wherein the illustrative composition comprises non-encapsulated spray dried curcumin (instant release), a first color delivery system comprising first core particles at least partially coated with a first beetroot colorant, and wherein said at least partially coated first core particles are at least partially encapsulated by a first methyl cellulose encapsulant; and a second color delivery system comprising second core particles at least partially coated with a second spirulina colorant, and wherein the at least partially coated second core particles are at least partially encapsulated by a second methyl cellulose encapsulant, wherein the first and second delivery systems release their respective colorants at substantially the same time in response to mechanical agitation (stirring), when the composition is added to the milk.

FIG. 6 is a photograph of cold milk (from about 0 °C to about 5 °C) after the initial addition of an illustrative composition thereto (left, having a milk chocolate color) and after mixing (right, having a dark chocolate color), wherein the illustrative composition comprises a non-encapsulated cocoa color (instant release), a first color delivery system comprising first core particles at least partially coated with a first beetroot colorant, and wherein the at least partially coated first core particles are at least partially encapsulated by a first methyl cellulose encapsulant; and a second color delivery system comprising second core particles at least partially coated with a second spirulina colorant, and wherein the at least partially coated second core particles are at least partially encapsulated by a second methyl cellulose encapsulant, wherein the first and second delivery systems release their respective colorants at substantially the same time in response to mechanical agitation (stirring), when the composition is added to the milk.

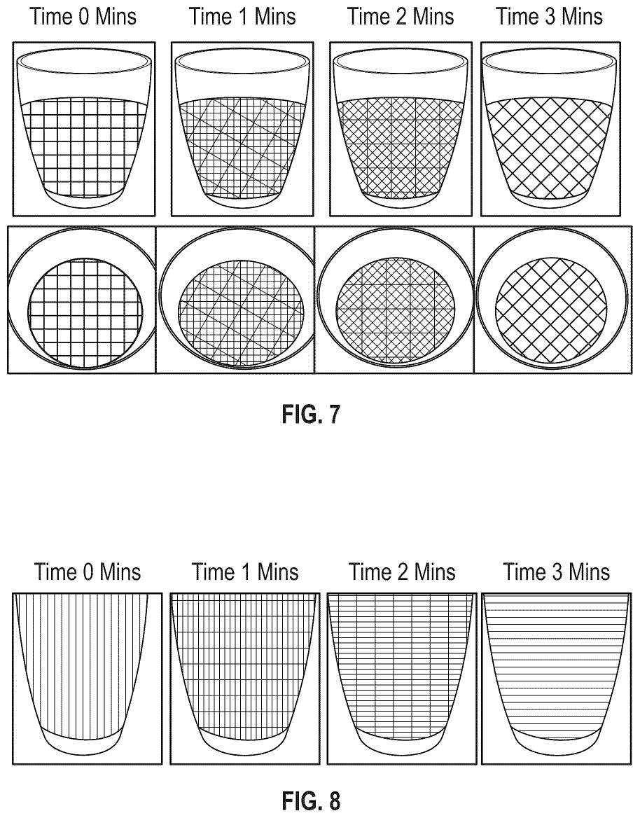

FIG. 7 is a photograph of cold milk (from about 0 °C to about 5 °C) after the initial addition of an illustrative composition thereto (left, having a yellow color), after 1 minute (having a yellowish/orange color), after 2 minutes (having an orangish/yellow color), and after 3 minutes (having a mango/orange color), wherein the illustrative composition comprises non-encapsulated spray dried curcumin (instant release), a first color delivery system comprising first core particles at least partially coated with a first beetroot colorant, and wherein the at least partially coated first core particles are at least partially encapsulated by a first methyl cellulose encapsulant, wherein the first color delivery system releases its first beetroot colorant in response to mechanical agitation (stirring), when the composition is added to the milk.

FIG. 8 is a photograph of cold milk (from about 0 °C to about 5 °C) after the initial addition of an illustrative composition thereto (left, having a strawberry pink color), after 1 minute (having a pinkish/purple color), after 2 minutes (having a purplish/pink color), and after 3 minutes (having a blueberry/purple color), wherein the illustrative composition comprises non-encapsulated spray dried beetroot (instant release), a first color delivery system comprising first core particles at least partially coated with a first spirulina colorant, and wherein the at least partially coated first core particles are at least partially encapsulated by a first methyl cellulose encapsulant, wherein the first color delivery system releases its first spirulina colorant in response to mechanical agitation (stirring), when the composition is added to the milk.

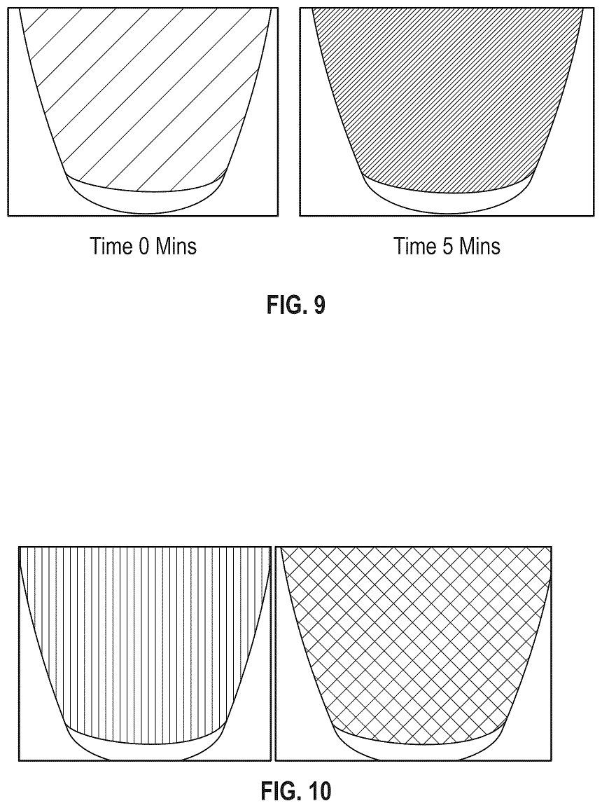

FIG. 9 is a photograph of milk after the initial addition of an illustrative composition thereto (left, having a milk chocolate color) and after heating to at least 50 °C (right, having a dark chocolate color), wherein the illustrative composition comprises non-encapsulated spray dried curcumin (instant release), a first color delivery system comprising first core particles at least partially coated with a first beetroot colorant, and wherein the at least partially coated first core particles are at least partially encapsulated by a first fat (dehydrogenated rapeseed oil) encapsulant; and a second color delivery system comprising second core particles at least partially coated with a second spirulina colorant, and wherein the at least partially coated second core particles are at least partially encapsulated by a second fat (dehydrogenated rapeseed oil) encapsulant, wherein the first and second delivery systems release their respective colorants in response to temperatures exceeding 60 °C, when the composition is added to the milk.

FIG. 10 is a photograph of hot milk with vitamins after the initial addition of an illustrative composition thereto (left, having a strawberry/banana color) and after mixing (right, having a light orange color), wherein the illustrative composition comprises non-encapsulated spray dried curcumin (instant release), a first color delivery system comprising first core particles at least partially coated with a first beetroot colorant, and wherein said at least partially coated first core particles are at least partially encapsulated by a first fat (dehydrogenated rapeseed oil) encapsulant, wherein the first color delivery system releases its first beetroot colorant in response to temperatures exceeding 60 °C, when the composition is added to the milk.

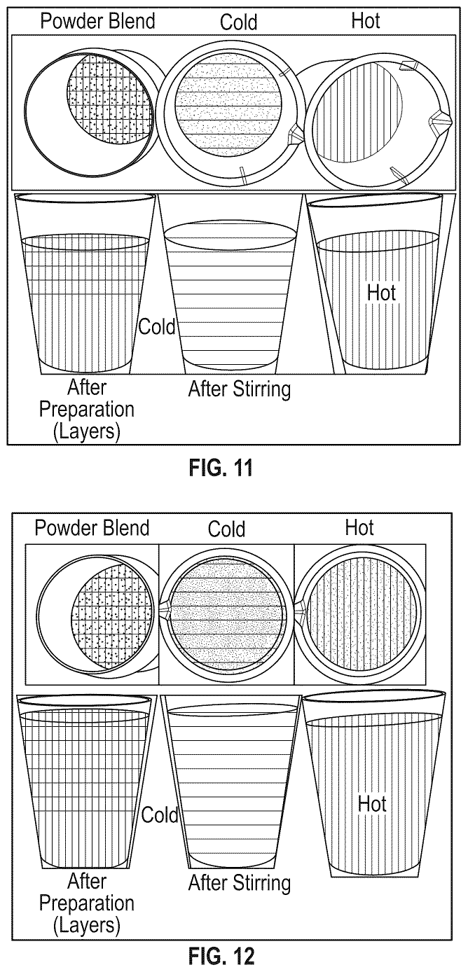

FIG. 11 is a photograph of an energizing drink having blueberry flavor, green bean coffee and guarana after the initial addition of an illustrative composition thereto (left, having a reddish/purple color on top and a pink color on bottom), after mixing (middle, having a purple color), and after heating to at least 50 °C (right, having a pink color), wherein the illustrative composition comprises a first color delivery system comprising first core particles at least partially coated with a first beetroot colorant, and wherein said at least partially coated first core particles are at least partially encapsulated by a first methyl cellulose encapsulant; and a second color delivery system comprising second core particles at least partially coated with a second spirulina colorant, and wherein said at least partially coated second core particles are at least partially encapsulated by a second fat (dehydrogenated rapeseed oil) encapsulant, wherein the first and second delivery systems release their respective colorants at different times in response to temperature changes, when the composition is added to the milk.

FIG. 12 is a photograph of an energizing drink having pomegranate flavor, acerola (vitamin C) and Panax ginseng after the initial addition of an illustrative composition thereto (left, having a reddish/purple color on top and a pink color on bottom), after mixing (middle, having a purple color), and after heating to at least 50 °C (right, having a pink color), wherein the illustrative composition comprises a first color delivery system comprising first core particles at least partially coated with a first beetroot colorant, and wherein said at least partially coated first core particles are at least partially encapsulated by a first methyl cellulose encapsulant; and a second color delivery system comprising second core particles at least partially coated with a second spirulina colorant, and wherein the at least partially coated second core particles are at least partially encapsulated by a second fat (dehydrogenated rapeseed oil) encapsulant, wherein the first and second delivery systems release their respective colorants at different times in response to temperature changes, when the composition is added to the milk.

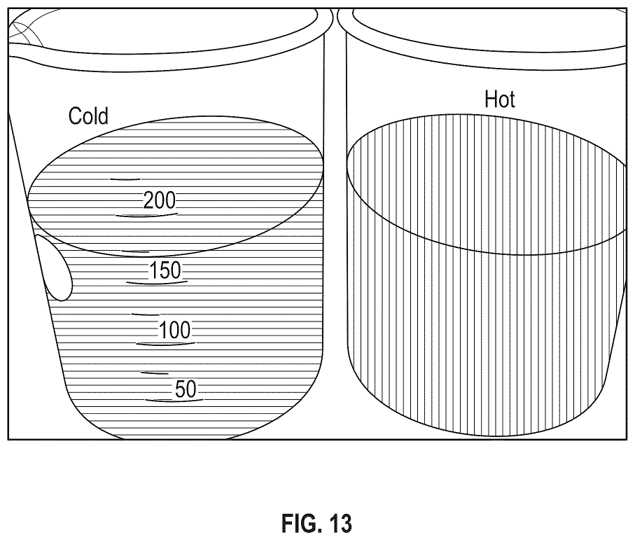

FIG. 13 is a photograph of cold milk (from about 0 °C to about 5 °C) after initial addition of an illustrative composition having a coffee flavor thereto (left, having a blue color) and after heating to at least 50 °C (right, having a pink color), wherein the illustrative composition comprises non-encapsulated spray dried spirulina and maltodextrin (instant release), and a first color delivery system comprising first core particles at least partially coated with a first beetroot colorant, and wherein the at least partially coated first core particles are at least partially encapsulated by a first fat (dehydrogenated rapeseed oil) encapsulant, wherein the first color delivery system releases its first beetroot colorant in response to temperatures exceeding 60 °C, when the composition is added to the milk.

The following examples are given solely for the purpose of illustration and are not to be construed as limitations of the present invention, as many variations of the invention are possible without departing from the spirit and scope of the present disclosure.

The following illustrative compositions were formed.

Example 1—A betanin pigment obtained from beetroot (first colorant) was dissolved in water and coated onto first core particles composed of sucrose via rotor granulation. A first encapsulant composed of high melting fat hydrogenated rapeseed oil was thereafter sprayed on the fluidized first colorant-coated first core particles. The first colorant (beetroot) was present in an amount of 12.5%, based on the total weight of the composition. The first encapsulant was present in an amount of 16.67%, based on the total weight of the composition.

Example 2—A spirulina pigment (VegeBrite® Ultimate, commercially available from Givaudan-Naturex) (second colorant) was dissolved in water and coated onto second core particles composed of sucrose via rotor granulation. A second encapsulant composed of high melting fat hydrogenated rapeseed oil was thereafter sprayed on the fluidized second colorant-coated second core particles. The second colorant (spirulina) was present in an amount of 12.5%, based on the total weight of the composition. The second encapsulant was present in an amount of 16.67%, based on the total weight of the composition.

Examples 1 and 2 were added to hot milk having a temperature of above 60 °C and demonstrated good color release performance.

Example 3—A betanin pigment obtained from beetroot (first colorant) was dissolved in water and coated onto first core particles composed of sorbitol via bottom spray coating (Wurster coating). A first encapsulant composed of methyl cellulose was thereafter sprayed on the fluidized first core particles. The first colorant (beetroot) was present in an amount of 9.5%, based on the total weight of the composition. The first encapsulant was present in an amount of 7.3%, based on the total weight of the composition.

Example 4—A spirulina pigment (VegeBrite® Ultimate, commercially available from Givaudan-Naturex) (second colorant) was dissolved in water and coated onto second core particles composed of sorbitol via bottom spray coating (Wurster coating). A second encapsulant composed of methyl cellulose was thereafter sprayed on the fluidized second core particles. The second colorant (spirulina) was present in an amount of 9.5%, based on the total weight of the composition. The second encapsulant was present in an amount of 7.3%, based on the total weight of the composition.

Examples 3 and 4 were added to cold milk having a temperature of below 40 °C and demonstrated good color release performance.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A composition for effecting color change of a consumable, wherein the composition comprises a first color delivery system comprising first core particles at least partially coated with a first colorant, and wherein said at least partially coated first core particles are at least partially encapsulated by a first encapsulant, wherein the composition changes the color of the consumable in response to temperature, mechanical agitation, passage of time, or combinations thereof.

2. The composition of claim 1 further comprising a second color delivery system comprising second core particles at least partially coated with a second colorant comprising a color that is different from the color of said first colorant, and wherein said at least partially coated second core particles are at least partially encapsulated by a second encapsulant.

3. The composition of claim 2, wherein the first encapsulant is the same or different than the second encapsulant.

4. The composition of claim 1, wherein the first encapsulant comprises a fat or a carbohydrate.

5. The composition of claim 4, wherein the carbohydrate comprises a cellulose derivative.

6. The composition of claim 5, wherein the cellulose derivative comprises an alkyl cellulose.

7. The composition of claim 6, wherein the alkyl cellulose comprises methyl cellulose.

8. The composition of claim 4, wherein the fat has a melting point of at least 50 °C.

9. The composition of claim 8, wherein the fat comprises a hydrogenated vegetable oil selected from the group consisting of almond oil, avocado oil, canola oil, coconut oil, corn oil, cottonseed oil, flaxseed oil, hazelnut oil, illipe oil, linseed oil, palm oil, palm kernel oil, peanut oil, pecan oil, pumpkin seed oil, oat oil, olive oil, rapeseed oil, safflower oil, sesame oil, shea oil, soybean oil, sunflower oil, walnut oil, and mixtures thereof.

10. The composition of claim 2, wherein the first encapsulant comprises a fat and the second encapsulant comprises a cellulose derivative.

11. The composition of claim 10, wherein the first encapsulant comprises a hydrogenated vegetable oil and the second encapsulant comprises methylcellulose.

12. The composition of claim 1 in the form of a powder and wherein the first core particles are solid having a particle size of from 0.02 mm to 3 mm.

13. The composition of claim 1, wherein the first core particles comprise sucrose, sorbitol, or mixtures thereof.

14. The composition of claim 1, wherein the first colorant is at least partially encapsulated in a carbohydrate matrix selected from the group consisting of modified starch, a gum, a cellulose derivative, and mixtures thereof.

15. The composition of claim 14, wherein the carbohydrate matrix comprises maltodextrin.

16. The composition of claim 1 further comprising one or more non-encapsulated colorants.

17. The composition of claim 1, wherein the first colorant is present in an amount of 5 wt. % to 25 wt. %, the first encapsulant is present in an amount of 5 wt. % to 30 wt. %, and the first core particles are present in an amount of 50 wt. % to 80 wt. %, based on the total weight of the composition.

18. A beverage comprising the composition of claim 1.

19. A beverage powder mix comprising a first color delivery system comprising first core particles at least partially coated with a first colorant, and wherein said at least partially coated first core particles are at least partially encapsulated by a first encapsulant; and a second color delivery system comprising second core particles at least partially coated with a second colorant comprising a color that is different from the color of said first colorant, and wherein said at least partially coated second core particles are at least partially encapsulated by a second encapsulant, wherein the powder mix changes the color of a beverage over a period of time in response to temperature, mechanical agitation, passage of time, or combinations thereof, when the powder mix is added to the beverage.

20. A process for changing the color of a consumable comprising:
adding the composition of claim 1 to the consumable;
i) altering the temperature of the consumable to a predetermined temperature that is sufficient to release the first colorant,
ii) mixing the consumable for a predetermined period of time that is sufficient to release the first colorant, or
iii) allowing the consumable to sit for a predetermined period of time that is sufficient to release the first colorant.
